(19) United States
(12) Patent Application Publication
(10) Pub. No.: US 2012/0155072 A1
(43) Pub. Date: Jun. 21, 2012

(54) LED TUBE LAMP

(75) Inventor: SHAO-HAN CHANG, Tu-Cheng (TW)

(73) Assignee: HON HAI PRECISION INDUSTRY CO., LTD., Tu-Cheng (TW)

(21) Appl. No.: 13/117,150

(22) Filed: May 27, 2011

(30) Foreign Application Priority Data
Dec. 20, 2010 (CN) 201010596217.5

(51) Int. Cl. F21V 29/00

(52) U.S. Cl. 362/218

(57) ABSTRACT

An LED tube lamp includes a heat sink, an LED substrate, a cover fixed to the heat sink. The cover includes a first surface, a second surface and at least one incident end facing the LEDs, each of the at least one incident end includes an incident face and a reflective face. Light beams from the LEDs enter the cover from the incident face and are reflected by the reflective face, the light beams reflected by the reflective faces are internally reflected by the first surface and the second surface until escaping outside through the cover.

### BACKGROUND

1. Technical Field

The present disclosure relates to light emitting diode (LED) illuminating devices and, particularly to an LED tube lamp.

2. Description of Related Art

Compared to traditional light sources, light emitting diodes (LEDs) have advantages, such as high luminous efficiency, low power consumption, and long service life. LED lights are widely used in many applications to replace traditional fluorescent lamps and neon tube lamps.

Many LED tube lamps include a cylindrical tube and an LED substrate. However, in order to increase the illumination, a type of LED array including a plurality of LEDs connected in series arranged on the LED substrate is used in LED tube lamps. All the LEDs in the LED array emit light in the same direction, with this kind of LED array the light divergence angle of LED tube lamps cannot be increased. Further, high brightness LEDs cause light spots on the lighting surface of the LED lighting device. In order to reduce or eliminate the light spots and achieve a uniform lighting surface, an extra light diffusion film is needed, which may absorb part of the light from the light-emitting diodes, reducing brightness of emitted light.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is an assembled, isometric view of an LED tube lamp in accordance with a first embodiment.

FIG. 2 is a cross-sectional view of the LED tube lamp of FIG. 1, taken along line II-II.

FIG. 3 is a schematic, cross-sectional view showing a cover of the LED tube lamp of FIG. 1.

FIG. 4 is a schematic, cross-sectional view showing part of light beams from side rows of LEDs passing through the cover of the LED tube lamp of FIG. 1.

FIG. 5 is a schematic, cross-sectional view showing other part of light beams from side rows of LEDs passing through the cover of the LED tube lamp of FIG. 1.

FIG. 6 is a schematic, cross-sectional view showing light beams from a middle row of LEDs passing through the cover of the LED tube lamp of FIG. 1.

FIG. 7 is a schematic, cross-sectional view of an LED tube lamp in accordance with a second embodiment.

### DETAILED DESCRIPTION

Embodiments of the present disclosure are now described in detail, with reference to the accompanying drawings.

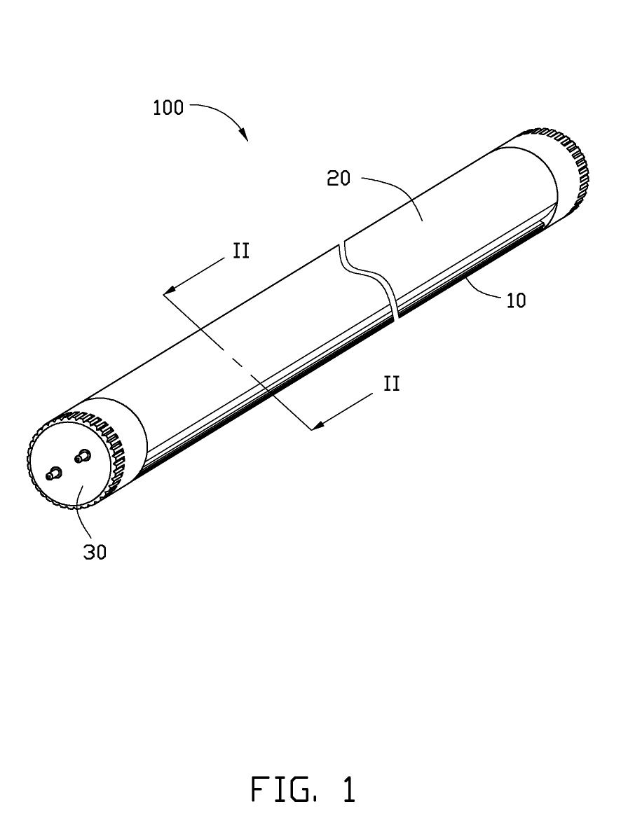

Referring to FIG. 1, a first embodiment of an LED tube lamp 100 is illustrated. The LED tube lamp 100 includes a heat sink 10, a cover 20, and a pair of connectors 30. The cover 20 is fixed to the heat sink 10, has an elongated structure and has an arc-shaped cross section. The connectors 30 are arranged at opposite ends of the LED tube lamp 100 and connect to a coupling connector (not shown), to electrically connect the LED tube lamp 100 to a power source.

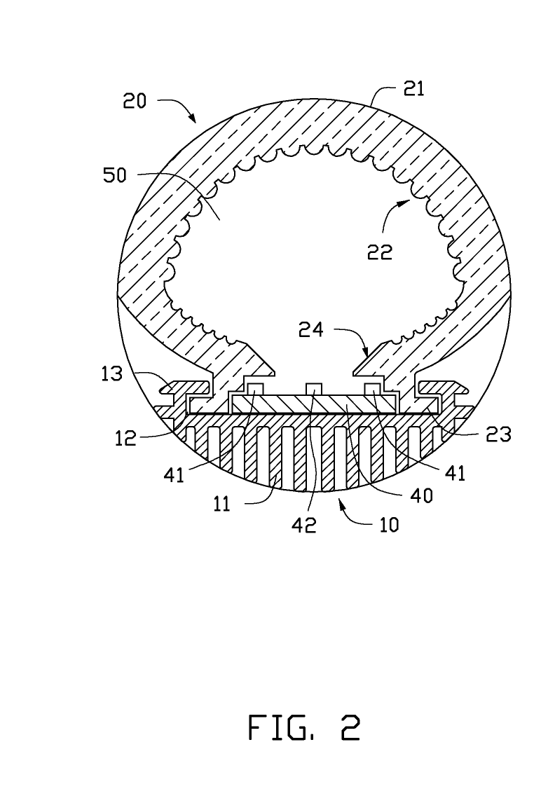

Referring to FIG. 2, the LED tube lamp 100 further includes an LED substrate 40 mounted on the heat sink 10 and electrically connected to the connector 30. A plurality of LEDs 41 is arranged on the LED substrate 40. The LEDs 41 can be chosen for having a large light divergence angle, high illumination, and/or being colored according to actual requirements.

The heat sink 10 has an elongated structure and is made of metal with good heat conductivity, such as copper or aluminum. In another embodiment, the heat sink 10 can be ceramic. The heat sink 10 includes a number of cooling fins 11 arranged on the bottom surface of the heat sink 10 to increase the heat dissipation area. A recess 12 is defined in the top surface of the heat sink 10 for receiving the LED substrate 40. In this embodiment, a heat-conductive medium (not shown) can be arranged between the LED substrate 40 and the inner surface of the recess 12, for transferring the heat generated by the LEDs 41 from the LED substrate 40 to the cooling fins 11. In this embodiment, the heat-conductive medium can be thermally conductive glue or a heat-conductive plate. In this embodiment, the LED substrate 40 is fixed on the heat sink 10 with screws (not shown).

The heat sink 10 further includes connecting portions 13. In the embodiment, the connecting portions 13 are grooves. The cover 20 includes two projecting members 23 extending outward from the opposite ends of the cover 20. The projecting members 23 are respectively received in the connecting portions 13, thus fixing the cover 20 to the heat sink 10. The cover 20 is arranged facing the LED substrate 40, and a space 50 is defined between the cover 20 and the LED substrate 40. The cover 20 further includes a first surface 21, a second surface 22, and two incident ends 24. The cover 20 is transparent and can be made of plastic or glass, such as polymethyl methacrylate (PMMA).

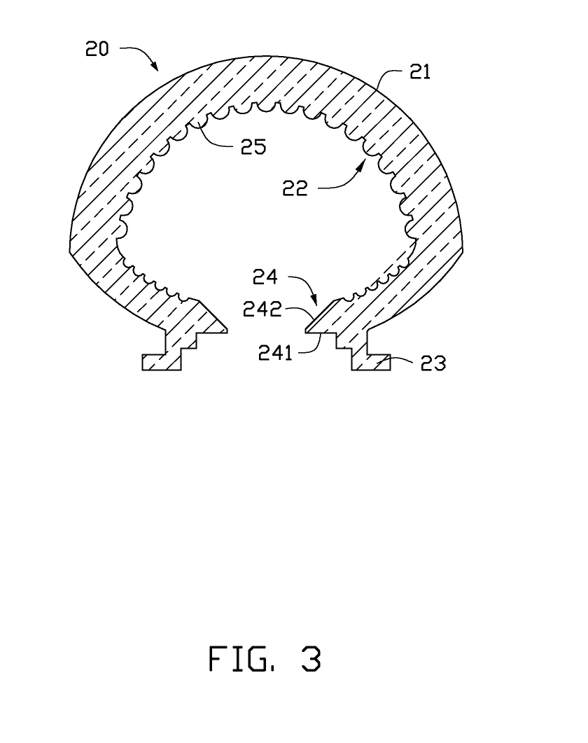

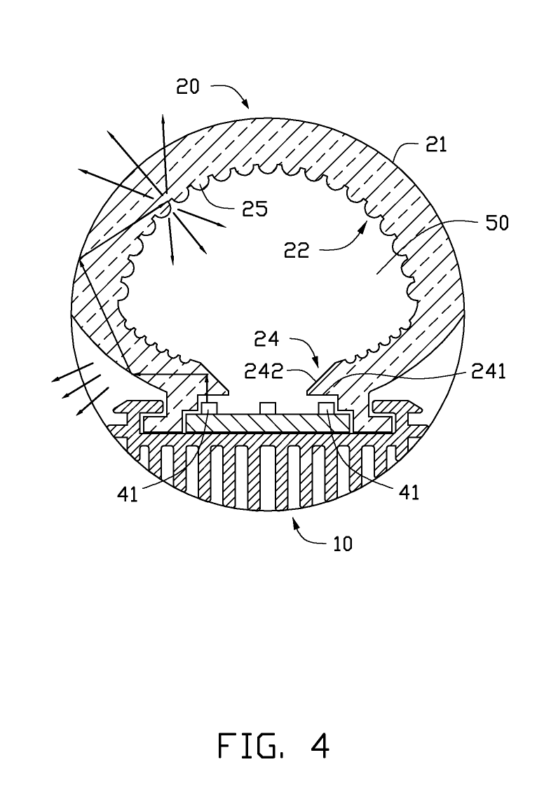

Referring to FIGS. 3 and 4, each of the incident ends 24 includes an incident face 241 and a reflective face 242. In the first embodiment, three parallel rows of the LEDs including two side rows of LEDs 41 and a middle row of LEDs 42 are arranged on the LED substrate 40 side by side. Each incident face 241 is arranged above a side row of LEDs 41. In this embodiment, the reflective face 242 is substantially mirror-like and tilted about 45 degrees relative to the light emitting direction of the LEDs 41. A number of accentuated portions 25 such as protuberances and/or recesses are defined on the second surface 22.

The light beams from the LEDs 41 enter the cover 20 from the incident faces 241. The light beams, enter through the incident faces 241 and are reflected by the reflective faces 242. After being reflected by the reflective faces 242, some of the light beams may be internally reflected for a time by the first surface 21 and the second surface 22, escaping through the first surface 21 or the second surface 22. Those light beams emitted from the first surface 21 are refracted and are spread out. Similarly, the light beams emitted from the second surface 22 are refracted by the accentuated portions 25 and enter the space 50. The light beams traveling in the space 50 enter the cover 20 again through the second surface 22, and continue through the above process until they finally escape to outside through the first surface 21.

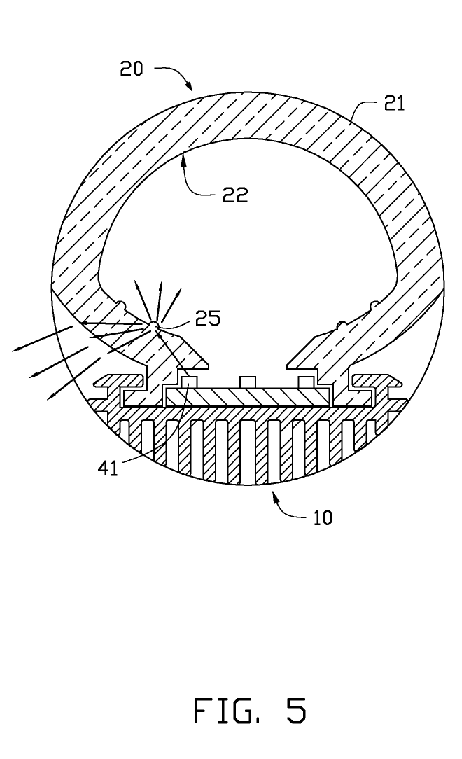

Referring to FIG. 5, after the light beams from the LEDs 41 enter the cover 20 from the incident faces 241, some of the light beams may reach the first surface 21 or the second surface 22 directly and may be internally reflected by the first surface 21 and the second surface 22. Similarly, those light beams escape through the first surface 21 or the second surface 22. The light beams emitted from the first surface 21 are refracted and are spread out. Similarly, the light beams emitted from the second surface 22 are refracted by the accentuated portions 25 and enter the space 50. The light beams traveling in the space 50 enter the cover 20 again through the second surface 22, and continue through the above process until they finally escape outside through the first surface 21.

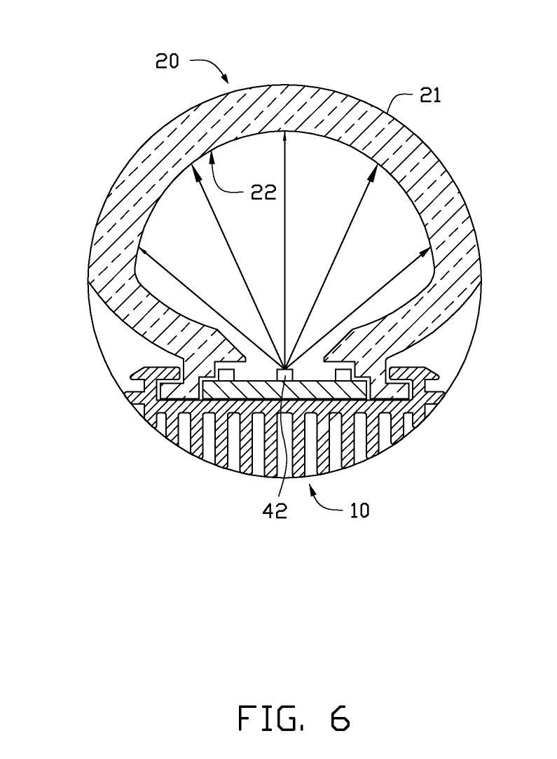

Referring to FIG. 6, the light beams from the middle row of the LEDs 42 enter the space 50 directly. Then those light beams enter the cover 20 through the second surface 22, and continue through the above process described in FIG. 4 until they finally escape to outside through the first surface 21.. The middle row of the LEDs 41 is employed to enlarge the illumination of the forward direction of the LED tube lamp 100.

Because the light beams from the side rows of LEDs 41 are repeatedly reflected and refracted in the cover 20, and then escape to outside through the first surface 21, the light divergence angle of the LED tube lamp 100 can be increased. Furthermore, the light beams are refracted and are diffused by the accentuated portions 25, thereby achieving a uniform and soft effect.

In another embodiment, a scatter layer (not shown) is arranged on the first surface 21 to scatter the light beams emitted from the first surface 21, thus achieving a homogeneous illumination effect. The scatter layer can be a coating of scatter material coated on the first surface 21, or a film of scatter material arranged on the first surface 21.

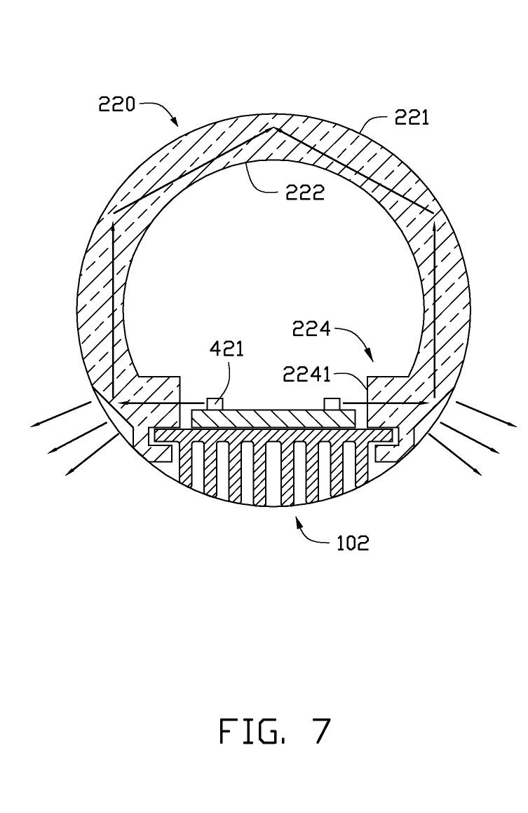

Referring to FIG. 7, an LED tube lamp 120 according to a second embodiment is illustrated. The LED tube lamp 120 is similar to the LED tube lamp 100 that is described above. The LED tube lamp 120 includes a cover 220 and a LED substrate (not labeled) including a number of LEDs 421 arranged on the LED substrate. The difference between the lamp 120 and 100 is that the LEDs 421 are side view LEDs, the side view LEDs can emit light in side direction substantially parallel with the LED substrate. The cover 220 further includes a first, outside surface 221, a second, inner surface 222 and two incident ends 224. Each of the incident ends 224 includes an incident face 2241 and a reflective face 2242. In this embodiment, two parallel rows of the LEDs 421 are arranged on the LED substrate. The two incident ends 224 face the two rows of the LEDs 421 respectively. The reflective face 2242 is mirror-like and tilted about 45 degrees relative to the light emitting direction of the LEDs 421. The light beams, enter through the incident face 2241 and are reflected by the reflective face 2242. Similarly, those light beams are reflected and are refracted as the process described in the first embodiment until they finally escape outside through the first surface 221.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An LED tube lamp, comprising:
a heat sink;
an LED substrate mounted on the heat sink and comprising a plurality of LEDs; and
a cover fixed to the heat sink, and covering the plurality of LEDs;
wherein the cover comprises a first surface, a second surface and at least one incident end facing the LEDs, each of the at least one incident end comprises an incident face and a reflective face, light beams from the LEDs enter the cover from the incident face and are reflected by the reflective face, the light beams reflected by the reflective faces are internally reflected by the first surface and the second surface until escape outside through the cover.

2. The LED tube lamp according to claim 1, wherein the reflective face is a mirror-like reflective face.

3. The LED tube lamp according to claim 2, wherein the reflective face is tilted about 45 degrees relative to a lighting direction of the LEDs.

4. The LED tube lamp according to claim 1, wherein the first cover is made of transparent material.

5. The LED tube lamp according to claim 1, wherein a plurality of accentuated portions configured for diffusing the light beams are defined on the second surface.

6. The LED tube lamp according to claim 5, wherein the plurality of accentuated portions are protuberances defined on the second surface.

7. The LED tube lamp according to claim 5, wherein the plurality of accentuated portions are recesses defined on the second surface

8. The LED tube lamp according to claim 1, further comprising at least one LED emitting light to the second surface directly.

9. The LED tube lamp according to claim 1, wherein the heat sink defines two grooves, the cover comprises two projecting members extending inwardly from the opposite ends of the cover, the two projecting members are respectively received in the grooves.

10. The LED tube lamp according to claim 1, where a recess is defined in a top surface of the heat sink for receiving the LED substrate.

11. The LED tube lamp according to claim 1, wherein a plurality of cooling fins are arranged on a bottom surface of the heat sink.
